(19) United States
(12) Patent Application Publication
(10) Pub. No.: US 2025/0212925 A1
(43) Pub. Date: Jul. 3, 2025

(54) PLANT-ONLY REPLACEMENT SYSTEM FOR METHYLCELLULOSE IN FOOD PRODUCTS AND METHODS OF PREPARATION THEREOF

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/850,077

(22) PCT Filed: Apr. 13, 2023
(86) PCT No.: PCT/IB2023/053779

§ 371 Date: Sep. 27, 2024

(30) Foreign Application Priority Data
Apr. 19, 2022 (US) 63/332620
Apr. 13, 2023 (WO) PCT/IB2023/053779

(51) Int. Cl. A23L 29/212; A23L 29/231; A23L 29/238; A23L 29/244

(52) U.S. Cl. CPC A23L 29/212; A23L 29/231; A23L 29/238; A23L 29/244

(57) ABSTRACT

A plant-only replacement system for methylcellulose in food products is provided. The plant-only replacement system for methylcellulose is prepared by mixing a) 15-20% by weight of a plant-derived protein source, b) 10-25% by weight of a vegetable binding agent source, c) 15-20% by weight of a fruit, seed, and vegetable fiber sources, d) 15-20% by weight of a whole grain fiber source, and e) 5-15% by weight of a plant-derived starch source at a temperature ranging between 60 degree Celsius and 105 degree Celsius. The plant-only ingredients of the replacement system for methylcellulose effectively function as emulsifiers, stabilizers, texturizing, and thickening agents in food products, replacing the conventional, non-plant-derived, synthetic, or highly processed additives and ingredients.

### CROSS-REFERENCE TO RELATED APPLICATIONS

This application claims priority to the U.S. provisional patent application.: 63/332,620, filed on Apr. 19, 2022 and PCT provisional patent application no.: PCT/IB2023/053779, filed on Apr. 13, 2023, title “PLANT-ONLY REPLACEMENT SYSTEM FOR METHYLCELLULOSE IN FOOD PRODUCTS AND METHODS OF PREPARATION THEREOF” and is incorporated by reference.

### TECHNICAL FIELD

The disclosed embodiments relate generally to food compositions and, more particularly, plant-only replacements for methyl cellulose (MC) and other chemicals, synthetic and/or highly processed additives in commercially available food products such as animal- or plant-based burgers, burger mixes, other meat-based products, meat alternative products, frozen food products, baked goods and other food products, including food product mixes in which methylcellulose is used. Such plant-only replacements are minimally processed and are free of synthetic food additives.

### BACKGROUND

Many commercially available, processed plant-based, and animal-based food products contain natural and/or synthetic food additives as well as other highly processed ingredients. Commercially available food products containing such additives vary greatly and include animal flesh-based (i.e., any one or more types of beef, pork, poultry, fish, shellfish, other seafood, etc.) or imitation meat-containing products based in whole or in part on plant-derived materials, or food products comprised of a combination both animal-sourced and plant-sourced materials. As an example, these food products may be, in one form, commercially available burgers, and burger mixes. Additives are found in all types of commercially available food products and serve as stabilizers, preservatives, colorants, flavor enhancers, sweeteners, thickeners, texturizers, and emulsifiers, and provide a variety of desired characteristics such as flavors, textures, appearance, and consistency. Additives can maximize yield, minimize shrinkage and cooking loss, and/or lead to more uniform blending or homogeneity of the food product or food product mix.

Commercially available, traditional burger products are generally highly processed foods. Traditional, meat-based burgers contain meat or animal flesh of some kind, added saturated fats, bone (carcass), highly processed ingredients, synthetic additives, and other ingredients that may be inappropriate for certain diets, e.g., vegetarian, vegan, salt-restricted, low-fat, low saturated fat, culturally- or religiously-restricted diets, etc. Even some commercially available “plant-based,” “plant-derived,” “meatless,” and “meat-free” burgers and other food products (depending on how those terms are defined by the manufacturers, or under definitions supported by a governmental authority in the location of manufacture) may contain animal-derived ingredients such as bone and meat broth or gelatin, dairy products, and certain saturated fats, sourced from animals slaughtered for food, or from animals raised primarily for dairy product production. Such animal-derived additions can render even these “plant-based” burgers and burger mixes inappropriate for vegetarians and vegans.

Some meat substitutes have been developed, in part, to mimic the qualities that some consumers of plant-based alternatives desire in a burger: a juicy center, red color, and meaty (or umami) taste but often a significant amount of saturated fat must be added to achieve a desired consistency or texture. Food additives in Traditional Burger Products may have physiological effects that many consumers do not want or do not want to risk if a healthier, more sustainable alternative is available that does not pose the downsides. Examples of food additives commonly found in Traditional Burger Products include silicon dioxide, sodium benzoate, sodium nitrite, and artificial food colors. Many such additives (particularly synthetic additives) can be harmful to consumers if consumed over prolonged periods. The food industry uses more than 7,000 synthetic and ultra-processed additives even though nature offers more than ten million compounds from more than 450,000 plants. Traditional bulking and texturing additives used in the food industry other than methylcellulose include, among others, guar gum, polydextrose, and mannitol.

Methyl cellulose (MC), a chemical compound derived from cellulose, is used in processed foods as a thickening, emulsifying, and binding additive and, due to its functioning as an (undigestible) fiber, in laxatives. Methylcellulose frequently is used as an inexpensive filler to add bulk and weight to processed foods and to bind and improve their texture. Similarly, gums used as additives such as xanthan gum, locust bean gum, and guar gum are ultra-processed. Each of these gum additives may negatively influence human intestinal bacteria and may inflame the intestinal environment that is in the process of healing.

It would be desirable to provide solely plant-derived (hereafter, “plant-only,” as further defined below) ingredients that replace typical, synthetic, artificial, and/or animal-derived (i.e., sourced directly or indirectly from an animal) ingredients found in Traditional Burger Products. A “plant-only” food product is free from dairy and other animal-derived ingredients and is minimally processed, with/or as a component of another food product, contributing to a desirable flavor, taste, texture, homogeneity, consistency, color, and appearance so as to be aesthetically pleasing to consumers.

### SUMMARY

Aspects of the disclosure are provided herein for a plant-only methylcellulose replacement system and components thereof to be used in place of Methylcellulose and other additives in a variety of food products. Commercially available, meat-based and/or imitation meat-based food products such as highly processed plant-based, plant-derived, meatless or meat-free burgers, burger mixes and other types of imitation meats and meat-alterative products (together, “Traditional Burger Products”) are one category of food products that can benefit from the substitution of methylcellulose and other traditional additives for plant-only ingredients and additives that are minimally processed. In the disclosed embodiments of the methylcellulose replacement system, plant-only ingredients effectively function as emulsifiers, stabilizers, texturizing, and thickening agents in food products, replacing the conventional, non-plant-derived, synthetic or highly processed additives and ingredients normally found in Traditional Burger Products. In the disclosed embodiments, plant-only food additive replacements (or replacement systems) are comprised of only minimally processed, naturally occurring (i.e., non-synthetic) ingredients sourced solely within the plant kingdoms.

According to an aspect of the disclosed embodiments, a plant-only replacement system for methylcellulose for use in food products is provided. The plant-only replacement system for methylcellulose for use in food products includes a) 15-20% by weight of a plant-derived protein source, b) 10-25% by weight of a vegetable binding agent source, c) 15-20% by weight of a fruit, seed, and vegetable fiber sources, d) 15-20% by weight of a whole grain fiber source, and e) 5-15% by weight of a plant-derived starch source.

According to an embodiment, the plant-derived protein source is selected from peas, lupine, mushrooms, quinoa, chickpeas, soy protein, pigeon pea, mung bean protein, peanut, pinto beans, oats, or combinations thereof.

According to another embodiment, the vegetable binding agent source is selected from aquafaba, quince seed, sugar beet pectin, garden cress root, okra mucilage powder, pumpkin pectin, carrot pomace pectin, sweet potato, taro, potato fiber or combinations thereof.

According to yet another embodiment, the fruit, seed, and vegetable fibers are selected from passion fruit peel pectin powder, albedo, chia, flaxseed, pea, quinoa fibers, oat fiber, soy fiber, orange pomace, Phaseolus vulgaris flour or combinations thereof.

According to yet another embodiment, the whole grain fiber source is selected from oats fiber, quinoa, amaranth, millet barley, bulgur wheat, farro, black rice, teff, rye, sorghum, triticale or combinations thereof.

According to yet another embodiment, the plant-derived starch source is selected from tapioca starch, potato starch, rice starch, jackfruit seed powder, taro starch, yam starch, arrowroot starch, cassava starch, wheat starch, or combinations thereof.

According to yet another embodiment, the food products comprise meat-based products, salads, sauces, condiments, bread, pastries, vegetable burger and burger mixes, nuggets, baked stable sauces, battered and fried food items.

According to another aspect of the disclosed embodiments, a method of preparing a plant-only replacement system for methylcellulose for use in food products is provided. The method includes mixing a) 15-20% by weight of a plant-derived protein source, b) 10-25% by weight of a vegetable binding agent source, c) 15-20% by weight of a fruit, seed, and vegetable fiber sources, d) 15-20% by weight of a whole grain fiber source, and e) 5-15% by weight of a plant-derived starch source at a temperature ranging between 60 degree Celsius and 105 degree Celsius for about 30 seconds to one minute to form a homogeneous mixture of the plant-only replacement system for methylcellulose.

According to an embodiment, the method includes blending the plant-only replacement system for methylcellulose with a formulation of the food product in a blender or bowl cutter.

According to another embodiment, the plant-derived protein source, the vegetable binding agent source, the fruit, seed, and vegetable fiber sources, the whole grain fiber source, and the plant-derived starch source are obtained as a dried powder.

According to yet another embodiment, the plant-only replacement system for methylcellulose is obtained as a gel or dough.

According to yet another embodiment, the plant-derived protein source is selected from peas, lupine, mushrooms, quinoa, chickpeas, soy protein, pigeon pea, mung bean protein, peanut, pinto beans, oats, or combinations thereof.

According to yet another embodiment, the vegetable binding agent source is selected from aquafaba, quince seed, sugar beet pectin, garden cress root, okra mucilage powder, pumpkin pectin, carrot pomace pectin, sweet potato, taro, potato fiber or combinations thereof.

According to yet another embodiment, the fruit, seed, and vegetable fiber is selected from passion fruit peel pectin powder, albedo, chia, flaxseed, pea, quinoa fibers, oat fiber, soy fiber, orange pomace, Phaseolus vulgaris flour or combinations thereof.

According to yet another embodiment, the whole grain fiber source is selected from oats fiber, quinoa, amaranth, millet barley, bulgur wheat, farro, black rice, teff, rye, sorghum, triticale or combinations thereof.

According to yet another embodiment, the plant-derived starch source is selected from tapioca starch, potato starch, rice starch, jackfruit seed powder, taro starch, yam starch, arrowroot starch, cassava starch, wheat starch, or combinations thereof.

According to yet another embodiment, the food products comprise meat-based products, salads, sauces, condiments, bread, pastries, vegetable burger and burger mixes, nuggets, baked stable sauces, battered and fried food items.

According to yet another embodiment, physical characterization data associated with ingredients of the plant-only replacement system for methylcellulose comprising the plant-derived protein source, the vegetable binding agent source, the fruit, seed, and vegetable fiber sources, the whole grain fiber source, and the plant-derived starch source is stored in a database, wherein a machine learning model determines a unique combination of the ingredients based on the physical characterization data to prepare the plant-only replacement system for methylcellulose.

According to yet another embodiment, the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

Several aspects of the disclosed embodiments are described below with reference to examples for illustration. However, one skilled in the relevant art will recognize that the disclosed embodiments can be practiced without one or more of the specific details or with other methods, components, materials, and so forth. In other instances, well-known structures, materials, or operations are not shown in detail to avoid obscuring the features of the disclosed embodiments. Furthermore, the features/aspects described can be practiced in various combinations, though only some of the combinations are described herein for conciseness.

### BRIEF DESCRIPTION OF THE DRAWINGS

Example embodiments of the disclosed embodiments will be described with reference to the accompanying drawings briefly described below.

FIG. 1 illustrates a flow chart of a method of preparing a plant-only replacement system for methylcellulose in food products according to the aspect of the present disclosed embodiments.

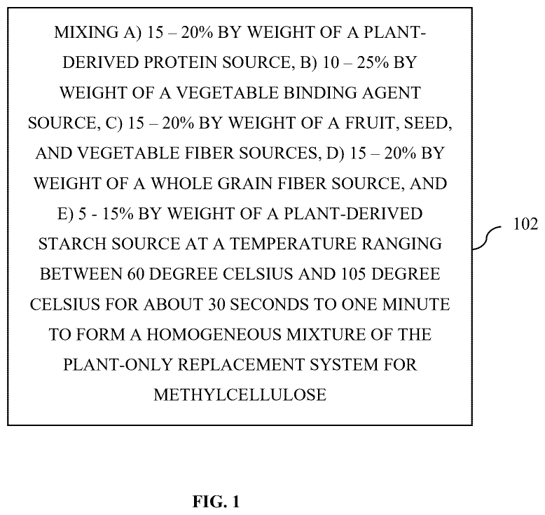

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprise one or more naturally occurring chemical compounds.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the disclosed embodiments are described with reference to the accompanying figures.

In the drawings, like reference numbers generally indicate identical, functionally similar, and/or structurally similar elements. The drawing in which an element first appears is indicated by the leftmost digit(s) in the corresponding reference number

### Definitions

“Methyl-cellulose” or “methylcellulose” refers to a compound derived from cellulose.

“Proteins” refers to large biomolecules and macromolecules that comprise one or more long chains of amino acid residues.

“Binding agent” refers to a substance that makes a loose mixture stick together.

“Fiber” refers to the portion of plant-derived food that cannot be completely broken down by human digestive enzymes.

“Starch” refers to a polymeric carbohydrate consisting of numerous glucose units.

“Bulking” refers to increasing the volume or weight of a product without affecting the overall taste and aroma of the product.

“Texturizing” refers to improving the overall consistency, texture by enhancing features like creaminess, viscosity, mouthfeel and taste.

“Fat” refers to a type of lipid consisting of triesters of glycerol and fatty acids or triglycerides.

“Fruit puree” refers to making fruit or vegetables into a thick, smooth sauce by crushing.

“Derived sugars” refers to modified monosaccharides.

“Cream” refers to a thick yellowish-white liquid.

“Emulsifier” refers to an agent used to help mix two substances that typically separate when they are combined.

“Thickener” refers to a substance that increases the viscosity of a liquid without substantially changing its other properties.

“Stabilizer” refers to an additive to food that helps to preserve its structure.

“Flavoring agent” refers to an additive that provides an additional taste or flavor.

“Homogeneous mixture” refers to a mixture that has the same proportions of its components throughout a given sample.

“Blender” refers to an appliance used to mix, crush, purée or emulsify food and other substances.

“Machine learning model” refers to computer software designed to recognize patterns or behaviors based on previous experience or data.

“Plant-derived” refers to ingredients extracted from a plant.

“Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any composition, formulation, system or the entire food product, that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible food or product, raw or cooked, savory or sweet, whether intended for human or animal consumption; a food product may be edible although not intended to be consumed on its own but, rather, incorporated into a second (or third) food product that is considered a consumable.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

A plant-only food product or formulation that is free from dairy and other animal-based ingredients is described herein that has desirable flavor, taste, texture, homogeneity, consistency, color and appearance so as to be aesthetically pleasing prior to consumption. The terms “plant-derived is used,” in this disclosure to refer to any ingredient, or component of a food product that is derived or extracted or obtained from plants with minimal processing. The term plant-only is used in this disclosure to refer to a system, composition, formulation or the entire food product itself, that is produced, developed or otherwise obtained directly or indirectly from one or more of the plant-derived ingredients, component that is obtained from plants with minimal processing. Although a plant-only, food product may consist of materials that are 100 percent sourced from one or more plants, the term also encompasses food products that may contain components or ingredients that are not obtained from plants. For example, while some of the water content of a food product may be derived from a plant source, water may also be added to the product from an external source. For example, in scenarios in which a plant-only system or plant-only food product is in the form of a gel or liquid, it is further understood that water can be included as a solvent or liquid carrier for the plant-only system or plant-only food product, where any amount of water (some or all) within the system or food product may or may not be derived from a plant source. In some embodiments, apart from added water, the plant-only food product consists entirely (100%) of components or ingredients from a plant genus (i.e., photosynthetic eukaryotes from the kingdom Plantae), and further excluding any component or ingredient that is dairy-based, that is from the animal genus (including animal fats and animal proteins) and also excludes any synthetically derived component or ingredient. The plant-derived ingredients of the food product described herein replace conventional animal-based ingredients, including milk, cream and eggs, as well as conventional additives such as gums, stabilizers, emulsifiers, preservatives, anti-freezing and anti-caking agents, binders, etc. The product formed solely from plant-derived ingredients is further free from gluten, soy, cholesterol and trans fatty acids.

The selection of specific plant-derived ingredients, or specific combinations (i.e., systems) of plant-derived ingredients provide effective functionalities such as emulsifiers, stabilizers, texturizing and thickening, fat replacement, sugars or other sweeteners, anti-freezing properties, anti-caking properties, etc., for the food product without the need to add such conventional, non-plant-derived additives. As used herein, the terms “agent,” “component,” or “ingredient” are used interchangeably and refer to a particular item that includes one or more chemical compounds (e.g., a food item from the plant species that comprises one or more naturally occurring chemical compounds). The term “plant-derived”, as used herein, refers to a product or formulation (e.g., food product or food formulation).

Embodiments disclosed herein include the plant-only methylcellulose replacement system, or components of it, for various ingredients or combinations of ingredients traditionally found in commercially available food products, including Traditional Burger Products. In some embodiments, the methylcellulose replacement system or aspects of the system replace both the meat and the additives of a Traditional Burger Product. In other embodiments, the methylcellulose replacement system or its components of it complement the ingredients of plant-based or plant-derived Traditional Burger Products, by providing more plant-derived protein and additive sources. In still other embodiments the methylcellulose replacement system replaces all animal-derived ingredients of, so-called “plant-derived,” “plant-based” or meatless, imitation meat food products, including food product mixes.

“Plant-only” products disclosed herein, as opposed to products labeled as “plant-derived,” “plant-based,” “meatless,” “meat-free” and the like, refer to food products whose ingredients, apart from any significant amount of water added, are derived solely from members of the plant or fungi kingdoms. That is, “plant-only” may refer to any agent, ingredient, or component of a food product, or the entire food product itself, that is produced, developed, or otherwise obtained directly or indirectly from one or more plants or fungi, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from outside the plant or fungi kingdoms. The US Food and Drug Administration currently has no accepted standard definition for labeling of food products described as “plant-based” or “plant-derived,” although a private trade organization, the Plant Based Food Association, has proposed voluntary standards to ensure consistency when the term “plant-based” is used on a product label (i.e., it contain no animal-sourced content), and seeks to certify—through its certification process—food products, including food product, that mixes meet this standard (https://www.plantbasedfoods.org/policy/labeling/). While the terminology used on a label for a plant-based food must be truthful under FDA regulations, nothing about the term “plant-based” currently requires a company to refrain from including some amount of meat, animal flesh, or other animal-sourced ingredients in such a product, so-labeled.

In certain embodiments, while some of the water content of a food product may be derived from a plant source, water may also be added to the product from an external source. For example, in scenarios in which a plant-only agent or system or plant-only food product is in the form of a gel or liquid, it is further understood that water can be included as a solvent or liquid carrier for the plant-only system, ingredient or food product, where any amount of water (some or all) within the system, ingredient or food product may or may not be derived from a plant source. In some embodiments, water may be added from an external source as part of the plant-only methylcellulose replacement system (or any other plant-only replacement system referenced herein). In other embodiments the plant-only methylcellulose replacement system may be available in a dried form; in certain embodiments, the dried form may be powdered; in other embodiments, the dried form of the methylcellulose replacement system may be in a partially powdered form; in other embodiments, it may be available in a semi-liquid or gel form; in other embodiments, it may be in a liquid or frozen form.

In the disclosed embodiments, apart from externally-sourced water, the plant-derived food product consists entirely of ingredients derived from members of the plant or fungi kingdoms, excluding any component or ingredient that is: (i) dairy-based or otherwise derived from any member of the animal kingdom, and (ii) more than minimally processed, and (ii) synthetic. In some embodiments, the plant-only methylcellulose replacement system, or components thereof, replaces conventional ingredients and additives found in meat-based food products such as commercially available meat-based burgers. In other embodiments, the methylcellulose replacement system replaces those additives found in commercially available plant-based, plant-derived, meatless, meat-free food products that range from burgers and burger mixes to baked goods and frozen food products.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, e.g., a food item from a member of the plant or fungi kingdoms that comprises one or more naturally occurring chemical compounds.

Together, all of the meat-based and/or plant-based meat alternative food products available commercially in any form will be referred to as “Traditional Burger Products.” These are distinguished from the plant-only burgers and burger mixes, collectively, plant-only “burger products,” as well as the plant-only methylcellulose replacement system of the disclosed embodiments. These terms are discussed in more detail and the categories are distinguished further below.

### Functionality and Parameters

TABLE 1
Parameter ranges associated with ingredients of the plant-only
replacement system for methylcellulose in food products

| Categories | Parameters | | | |
|---|---|---|---|---|
| Plant-derived | Water Holding | Oil Holding | Emulsion stability | Molecular weight |
| protein | Capacity | capacity | 35%-90% or more | 10-50 kDa |
| source | ~100%-600% | ~120%-175% | | |
| Vegetable | Emulsion | Water Holding | Oil Holding | |
| binding agent | stability | Capacity: | capacity: | |
| source(s): | 35% to 80% | 3-17 g/g or more | 2.97-11 g of oil/g | |
| | or more | | of sample | |
| Fibers from | Water holding | Mechanical | Hemicellulose | (This category is |
| fruit, seed, | capacity | properties like | fiber | related to Plant |
| and vegetable | 3.5-33 g/g or | Young's | content: >12% | derived fiber |
| source(s) | more | modulus: >3.015 | In some cases, | functionality) |
| | Note: WHC | KPa | overall total dietary | |
| | increases with | | fiber is taken under | |
| | temperature | | consideration | |
| Fibers from | Water holding | Mechanical | Hemicellulose | (This category is |
| whole grain | capacity | properties like | fiber | related to Plant |
| source(s) | 3.5-33 g/g or | Young's | content: >12% | derived fiber |
| | more | modulue: >3.015 | In some cases, | functionality) |
| | Note: WHC | KPa | overall total dietary | |
| | increases with | | fiber is taken under | |
| | temperature | | consideration | |
| Plant-derived | Pasting | Peak/Maximum | WAC/WHC: | Amylose |
| starch | Temperature: | viscosity (BU) | 415.13-595.26% | content: |
| source(s): | 68.6-69.3° C. | 0.1 and 0.9 Pa · s, | Swelling | 15-30% |
| | | at a shear rate | power: | |
| | | of 115 s⁻¹ | 20.76-26.92% | |

The selection of a specific combination of ingredients for plant-only products was determined using a proprietary machine learning (ML) platform, which blends ancestral wisdom of plant nutrition with biotechnology and ML to analyze members of the plant and fungi kingdoms and from plants and fungi, the compounds nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, bulking properties, texturizing properties, gelling properties, fat-replacement properties, etc.). Ayurvedic and/or other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-only ingredients was determined to yield an effective methylcellulose replacement formulation that can be used to forming a desirable food product or formulation that is effective as a substitute for conventional ingredients in Traditional Burger Products or for providing methylcellulose-like functionality in plant-only burger products and other food products.

As noted, the proprietary system identifies natural alternatives, i.e., plant-only alternatives to synthetic, artificial, and animal-derived products, and incorporates, among other things, traditional knowledge known as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksa—dry; or guru—heavy). The information recommended by the proprietary machine learning platform permits one to choose between hundreds of alternatives based on ingredients intended to alter a variety of properties to give optimal results for physiological functionality, health, and environmental sustainability.

The physical characterization data associated with the ingredients of the plant-only replacement system for methylcellulose in food products are stored in a database. A machine learning model determines a unique combination of ingredients based on the physical characterization data to prepare the plant-only replacement system for methylcellulose. The machine learning model identifies plant-based ingredient replacements based on the parameters and ranges to give the list of ingredients for each possible functionality.

### Example Embodiments

The disclosed embodiments are illustrated in further detail by the following non-limiting examples.

TABLE 2
Percent by weight of each of the preferred, essential, methylcellulose
replacement categories of ingredients in the plant-only
replacement system for methylcellulose in food products.

| | Preferred Weight |
|---|---|
| Preferred, Essential Plant-Only | Percent of the |
| Methylcellulose Replacement System Categories/Ingredients | Replacement System |
| 1. Plant-derived protein source(s): any one or more of peas, | 15-20 |
| lupine, mushrooms, quinoa, chickpeas, and/or any substitutes | |
| with the same properties and functionalities | |
| 2. Vegetable binding agent source(s): any one or more of | 10-25 |
| aquafaba, quince seed, sugar beet pectin, and/or any substitutes | |
| with the same properties and functionalities | |
| 3. Fibers from fruit, seed and vegetable source(s): any one or | 15-20 |
| more of passion fruit albedo, chia, flaxseed, pea, and/or any | |
| substitutes with the same properties and functionalities | |
| 4. Fibers from whole grain source(s): any one or more of oats, | 15-20 |
| quinoa, amaranth, millet, and/or any substitutes with the same | |
| properties and functionalities | |
| 5. Plant-derived starch source(s): any one or more of tapioca | 5-15 |
| starch, potato starch, rice starch, and/or any substitutes with the | |
| same properties and functionalities | |

In Table 2 within each category, the individual ingredients and combinations of two or more of them may be substituted for any of the others. In some embodiments, for each category, a complete blend consisting of all of the named ingredients may be prepared for use in the methylcellulose replacement system.

In alternative embodiments for each of the categories of Table 2, it is expected that any of the individual ingredients listed may be replaced with one or more substitute ingredients that impart the same properties and functionalities as each of the ingredients listed.

Further, although Table 2 provides a preferred, essential list of categories of ingredients with certain properties in the methylcellulose replacement system, substitutions for these ingredients in the replacement system may be made in alternative embodiments for compliance with dietary requirements; without limitation, such as food sensitivities and food allergies. For example, in the protein category, if peanuts are selected as a desired protein source for a particular food product, peanut allergies in consumers would require finding a suitable alternative to develop a formulation free from peanuts so that an anaphylactic (allergic) reaction would not be triggered in the consumer with such allergies.

The plant-only methylcellulose replacement system detailed in Table 2 as a component of a plant-only burger product or a Traditional Burger Product comprises generally between about 5 to about 10 percent of the total weight of the food product (see, e.g., Table 3 below), but may vary between as much as 0.5 percent to about 30 percent of the total weight, depending on the moisture content of the final food product (e.g., whether a plant-only burger product or a Traditional burger Product, whether a dry mix or other forms).

TABLE 3
Various replacement systems' ingredients and
combinations as components of plant-only burger products

| Preferred, Essential, Plant-Only Food Product | Preferred Weight |
|---|---|
| Replacement Systems and/or Individual Ingredients | Percent of Plant- |
| and Combinations | Only Burger Product |
| Protein sources (one or more of pea, mushroom, quinoa, | 10-20 |
| chickpeas or other substitute providing similar functionality | |
| and properties) | |
| Methyl Cellulose replacement system ingredients from all five | 5-10 |
| categories detailed in Table 2 (proteins; fibers from whole | |
| grains, fruits, seeds and vegetables; starches; and vegetable | |
| binders) within the ranges indicated for the replacement | |
| system (Table 2) | |
| Modified Starches replacement system (one or more of | 10-15 |
| tapioca, fava bean, sorghum, quinoa or other substitute | |
| providing similar functionality and properties) | |
| Oils providing high levels of omega-3 fatty acids, MUFAs, & | 10-12 |
| MCTs (e.g., sunflower oil, coconut oil, flaxseed oil, rice bran | |
| oil, or other oil providing such fats at desired levels) | |
| Gums and Carrageenan replacement system (one or more of | 10-15 |
| quince seed, apple, mesquite, almonds or other substitute | |
| providing similar functionality and properties) | |
| Shelf life extenders (one or more of garlic, black pepper, | 1-2 |
| oregano, bay laurel or other substitute providing similar | |
| functionality and properties) | |
| Umami flavor (one or more of shitake and other mushrooms, | 0.5-2 |
| tomatoes, garlic, lotus stem, onions, salt or other substitute | |
| providing similar functionality and properties) | |
| Flavorant, flavor enhancer, nutraceutical (one or more of | 0.5-1 |
| cumin, coriander, paprika, black pepper or other substitute | |
| providing similar functionality and properties) | |
| Flavor Enhancer (one or more of nutritional yeast, cashews or | 1-2 |
| other substitute providing similar functionality and properties) | |
| Mineral Salts (Himalayan pink salt, sea salt, or other substitute | 0.5-2 |
| providing similar functionality and properties.) | |
| Binding agents (one or more of chickpeas, oat fiber, aquafaba, | 5-10 |
| sugar beet pectin or other substitute providing similar | |
| functionality and properties) | |
| Leavening agent replacement system (one or more of plum | 0.5-1 |
| powder, apple cider vinegar, vegan buttermilk or other | |
| substitute providing similar functionality and properties) | |
| Leghemoglobin source(s) (one or more of beets, soy, red | 1-2 |
| radish or other substitute providing similar functionality and | |
| properties) | |
| Lipid peroxidation inhibitors (one or more of black pepper, | 0.5-2 |
| bay leaf, cumin or other substitute providing similar | |
| functionality and properties) | |

The methylcellulose replacement system may comprise, as a percent by weight of the food product in which it is added, depending on the type of food product and whether water or other liquid is included as part of the food product, including but not limited to Traditional Burger Products and plant-only burger products, between about 0.5 to about 30 percent, between about 1 to about 4 percent, between about 3 to about 5 percent, between about 4 to about 7 percent, between about 5 to about 8 percent between about 5 to about 10 percent, between about 7 to about 12 percent, between about 9 to about 14 percent, between about 10 to about 15 percent, between about 10 to about 20 percent, between about 12 to about 16 percent, between about 14 to about 18 percent, between about 15 to about 20 percent, between about 18 to about 23 percent, between about 20 to about 25 percent, between about 23 to about 28 percent and between about 25 to about 30 percent.

### Categories of Ingredients Among the Preferred, Essential Categories of Ingredients in the Methylcellulose Replacement System

A principal ingredient category in a methylcellulose replacement system for burger products in particular is one or more plant-derived protein sources such as chickpeas.

Category 1: plant-derived protein source(s): Chickpeas are one example of a protein (and also binder) source that can be used as part of the methylcellulose replacement system in food products. Alternative sources include mushrooms, peas, lupine and quinoa, each of which, in this methylcellulose replacement system designed by the machine learning system, may be interchanged with the others or may be used in combination as a blend of two or more of these ingredients, or with (or substituted by) other ingredients known to a person of ordinary skill that would provide the same characteristics and features for this category in the system. Further detail on this category is found in Table 8.

Chickpeas—Chickpeas (Cicer arietinum L.), commonly known as garbanzo beans, are an old world pulse (i.e., edible seeds) in the legume family. The main proteins found in chickpeas, similar to other legumes, are albumins and globulins. The protein isolate from chickpeas exhibits higher water holding capacity, oil binding capacity, emulsion stability and emulsion activity than the starch fractions. The legume is a rich source of protein (isolates comprise 72-85%) making it an excellent replacement for meat vegetarian and vegan dishes. It is an excellent source of carbohydrate, protein, fiber, B vitamins, and some minerals. Protein matrices formed can hold both water and fat. In some embodiments, chickpeas are provided in the methylcellulose replacement system as a finely ground powder. In other embodiments, chickpeas may be provided in a form containing moisture. Chickpeas promote the ayurvedic properties of Rasa: Madhura (Sweet), Kasaya (Astringent), Guna: Laghu (light) Ruksha (dry) and Viraya: Hima (Cold), as shown in Table 4.

In the disclosed embodiments the amount of plant-derived protein combination (one or more of peas, lupine, mushrooms, quinoa, chickpeas) as a percent of the methylcellulose replacement system weight ranges from between about 5 to about 35 percent, between about 5 to about 10 percent, between about 7 to about 12 percent, between about 8 to about 15 percent, between about 10 to about 17 percent, between about 12 to about 18 percent, between about 15 and about 20 percent, between about 17 to about 25 percent, between about 20 to about 28 percent, between about 25 to about 32 percent, and between about 28 to about 35 percent.

Category 2: vegetable binding agent source(s): Aquafaba is one example of a vegetable binding agent that can be used as part of the methylcellulose replacement system in food products. Alternative sources include quince seed and sugar beet pectin, each of which may be interchanged with the others or may be used in combination with two or more of these ingredients, or with (or substituted by) other ingredients known to a person of ordinary skill that would provide the same characteristics and features for this category in the system. Further detail on this category is found in Table 8.

Aquafaba—Aquafaba is a thick liquid containing a mix of starch and trace amounts of protein with emulsifying, binding, and thickening properties. It works well as a flavorless, odorless egg replacer in recipes where one tablespoon of aquafaba is equivalent to one egg yolk; two tablespoons are equivalent to one egg white, and three tablespoons are equivalent to one whole egg. The binding properties are attributed to water-soluble, insoluble carbohydrates that constitute oligosaccharides. Aquafaba is composed of protein, starches, and vegetable-binding molecules, but does not contain the same nutritional value or profile as a legume or an egg yolk. In some embodiments, aquafaba is provided in the methylcellulose replacement system in a dehydrated form and as a finely ground powder. In other embodiments, it is provided in liquid or gel form. Aquafaba promotes the Ayurvedic properties of Rasa: Kasaya (Astringent), Madhura (Sweet), Guna: Laghu (Light), Ruksha (Dry), Viraya: Hima (Cold), as shown in Table 4.

In the disclosed embodiments the amount of vegetable binding agent (individual ingredients or a combination of any two or more of aquafaba, quince seed, sugar beet pectin, etc.) as a percent of the methylcellulose replacement system weight ranges from between about 1 to about 30 percent, between about 1 to about 5 percent, between about 3 to about 10 percent, between about 5 to about 10 percent, between about 5 to about 15 percent, between about 10 to about 15 percent, between about 10 to about 20 percent, between about 15 and about 20 percent, between about 15 to about 25 percent, between about 20 to about 25 percent, and between about 25 to about 30 percent.

Category 3: Fibers from fruits, seeds and vegetable source(s): Passion fruit albedo is one example of a source of fruit-derived fiber that can be used as part of the methylcellulose replacement system in food products. Alternative sources include chia, flaxseed, and peas, each of which may be interchanged with the others or may be used in combination with two or more of these ingredients, or with (or substituted by) other ingredients known to a person of ordinary skill that would provide the same characteristics and features for this category in the system. Further detail on this category is found in Table 8.

Passion fruit (Passiflora edulis var. flavicarpa) is an important source of vitamins and minerals and an excellent source of carotenoids. It contains a high proportion of insoluble dietary fibers and a good ratio of insoluble to soluble dietary fibers. Passion fruit has a high water-holding capacity, swelling capacity, and moderate oil-holding capacity. The fat and water retention of passion fruit is related to the main components present in it, which include cellulose, hemicellulose, and pectin. The cellulose connects to interlink with hemicellulose and forms interspaces. This increases the surface area of fibers which contributes to the water and oil retention properties. In some embodiments, passion fruit albedo is provided in the system in a dehydrated, finely ground powder. In other embodiments, it may be provided in a moist or liquid form. Passion fruit promotes the Ayurvedic properties of Rasa: Madhura (Sweet), Amla (Sour), Guna: Guru (Heavy), Viraya: Ushna (Hot), Vipak: Katu (Pungent), as shown in Table 4.

In the disclosed embodiments, the amount of fiber from fruits, seeds, and vegetables (one or more of passion fruit albedo, chia, flaxseed, pea in addition to any substitutes providing the same properties and functionality as these ingredients) as a percent of the methylcellulose replacement system weight ranges from between about 5 to about 35 percent, between about 5 to about 10 percent, weight between about 7 to about 12 percent, between about 8 to about 15 percent, between about 10 to about 17 percent, between about 12 to about 18 percent, between about 15 and about 20 percent, between about 17 to about 25 percent, between about 20 to about 28 percent, between about 25 to about 32 percent, and between about 28 to about 35 percent.

Category 4: Fibers from whole grain source(s): Oats are one example of a source of whole grain-derived fiber that can be used as part of the methylcellulose replacement system in food products. Alternative sources include quinoa, amaranth, and millet, each of which may be interchanged with the others or may be used in combination with two or more of these ingredients, or with (or substituted by) other ingredients known to a person of ordinary skill that would provide the same characteristics and features (functionality, properties) for this category in the system. Further detail on this category is found in Table 8.

Oat fibers—Oats have a high content of insoluble fiber (85%-90%), and are composed of lignin, cellulose, and hemicellulose derived from the oat hull, or the outermost protective seed-coat of the oat kernel. The oat hull is composed mostly of non-starch polysaccharides, mainly xylans, glucans, arabinans, and galactans. These components allow oat fiber to be a water-activity modulator, bread-crumb humectant, texturizer, and friability reducer in low-moisture baked goods. In some embodiments oat fibers are provided in the system as a finely ground powder; in other embodiments. oat fibers may be provided in a moist form. Oat fibers promote the Ayurvedic properties of Rasa: Madhura (Sweet), Guna: Guru (Heavy), Viraya: Ushna (Hot), Vipak: Madhura (Sweet), as shown in Table 4.

In the disclosed embodiments, the amount of fiber from whole grains (one or more of oats, amaranth, or similar substitute that could provide the same functionality and properties as these ingredients) as a percent of the methylcellulose replacement system weight ranges from between about 5 to about 35 percent, between about 5 to about 10 percent, between about 7 to about 12 percent, between about 8 to about 15 percent, between about 10 to about 17 percent, between about 12 to about 18 percent, between about 15 and about 20 percent, between about 17 to about 25 percent, between about 20 to about 28 percent, between about 25 to about 32 percent, and between about 28 to about 35 percent.

Category 5: Plant-derived starch source(s) Tapioca is one example of a source of fruit-derived fiber that can be used as part of the methylcellulose replacement system in food products. Alternative sources include potatoes and rice, each of which may be interchanged with the others or may be used in combination with two or more of these ingredients, or with (or substituted by) other ingredients known to a person of ordinary skill that would provide the same characteristics and features (functionality, properties) for this category in the system. Further detail on this category is found in Table 8.

Tapioca starch is produced from cassava, a root vegetable of the cassava shrub. The cassava root is washed and pulp is made; a starchy liquid is extracted from the wet pulp and dried to produce tapioca starch. Tapioca starch has an amylopectin/amylose ratio of 80:15 and introduces a pulpy, gelatin-like texture to food products through its ability to develop high levels of cross-linking, and further contributes to the softness of meat alternatives, retaining springiness. Tapioca starch is capable of undergoing gelatinization and the resultant gel is soft, gummy and chewy, and, thus, affects viscosity, melting resistance and overrun, as indicated in Table 3. In some embodiments, tapioca starch is provided in the system in its usual dried, powdered form; in other embodiments, it may be provided in a dried, pelleted form or mixed with water or other plant-derived liquid to form a gel, paste or liquid. Tapioca starch promotes the Ayurvedic properties of Rasa (Madura—sweet), Lavana (salty), Guna (Shita), Virya (Hima/Sheeta—cold) and Vipaka (Madhura—sweet) as shown in Table 4.

In the disclosed embodiments the amount of plant-derived starch (one or more of tapioca starch, potato starch, rice starch, and any plant-only substitutes that could provide the same functionality and properties as these ingredients) as a percent of the methylcellulose replacement system weight ranges from between about 0.1 to about 25 percent, between about 0.1 to about 1 percent, between about 0.5 to about 2 percent, between about 1 to about 5 percent, between about 3 to about 7 percent, between about 5 to about 10 percent, between about 5 to about 15 percent, between about 8 and about 17 percent, between about 10 to about 15 percent, between about 12 to about 17 percent, between about 15 to about 20 percent, and between about 18 to about 25 percent.

The individual ingredients or various combinations of plant-only proteins (high water holding capacity), plant-only vegetable binding agents (natural emulsifiers), plant-only fruit, seed, vegetable fibers (water and oil retaining capacity), fibers from whole grains (binding agents), and plant-derived starches (texturizers and gelling agents) along with their Ayurvedic properties (as shown in Table 4), results in a plant only methylcellulose replacement system that may be used in whole or part in any variety of food products, the primary example of the disclosed embodiments for Traditional Burger Products and other burger products. Alone or in combination with a complete methylcellulose replacement system, the previously described ingredient categories (plant-derived protein sources, binding agents, fiber sources, and starches) are effective and natural components in the methylcellulose replacement system for burger products, baked products, or other food product categories in an amount of about 0.5% to up to 20% or more by weight of the food product, depending on the type of food product and the replacement ingredients needed or desired. Table 3 above shows preferred ranges percentages as a function of a plant-only burger product weight for various individual categories of ingredients for the methylcellulose replacement system (protein sources), as well as for other replacement systems and categories of other replacement ingredient blends.

TABLE 4
Plant-only methyl cellulose replacement system
categories of ingredients and their properties

Category /
Ingredient
Compounds
responsible for
the functionality
Physicochemical
properties
Ayurvedic
properties

| Category / | Compounds responsible for | Physicochemical | Ayurvedic |
|---|---|---|---|
| Ingredient | the functionality | properties | properties |
| Plant-derived | Chickpea starch and proteins | Protein isolates | Rasa: Madhura |
| protein source(s) | act as a binder. | exhibit higher water | (Sweet), kasaya |
| (one or more of | Protein isolates are high (~72 | holding capacity, oil | (Astringent) |
| peas, lupine, | to 85%) in globulins and | binding capacity, | Guna: Laghu (light) |
| mushrooms, | albumin, which have binding | emulsion stability | Ruksha (dry) |
| quinoa, chickpea, | proteins. Protein matrices | and emulsion | Viraya: Hima |
| and substitutes | formed hold water and fat. | activity than the | (Cold) |
| imparting the | | starch fractions. | |
| same properties | | Chickpea protein | |
| and functionalities | | isolates: Least | |
| etc.) | | gelation | |
| | | concentration: 10 to | |
| | | 14% | |
| | | Protein denaturation | |
| | | temperature: below | |
| | | 100 degrees | |
| | | Water holding | |
| | | capacity: 2.34 to | |
| | | 4.31 g/g | |
| | | Oil absorbing | |
| | | capacity: 3 to | |
| | | 5.74 g/g | |
| | | Emulsion stability: | |
| | | 18 to 26% | |
| | | Emulsion activity | |
| | | index: 0.89 to 1.3 | |
| Vegetable binding | The binding properties are | Freeze dried | Rasa: kasaya |
| agent(s) (one or | attributed to water soluble, | aquafaba | (Astringent), |
| more of aquafaba, | insoluble carbohydrates that | powder: Water | Madhura (Sweet) |
| quince seed, sugar | constitute oligosaccharides. | holding capacity: | Guna: Laghu (light) |
| beet, pectin, and | cellulose, starch and | 4.36 g/g | Ruksha (dry) |
| substitutes | hemicellulose and the | Oil absorbing | Viraya: Hima |
| imparting the | composition of proteins. The | capacity: 4.64 g/g | (Cold) |
| same properties | soluble carbohydrates have | Emulsion | |
| and functionalities | higher water binding | stability: 75.2% | |
| etc.) | capacities. The proteins | Emulsion | |
| | present are lipophilic, water | activity index: | |
| | soluble and insoluble | 1.09 | |
| | polysaccharides also absorb | Spray dried: | |
| | oil thus exhibiting higher oil | Water holding | |
| | absorbing properties. | capacity: 1.92 g/g | |
| | | Oil absorbing | |
| | | capacity: 1.98 g/g | |
| | | Emulsion | |
| | | stability: 74.4% | |
| | | Emulsion | |
| | | activity index: | |
| | | 1.30 | |
| Fibers from fruit, | Passion fruit has a higher | Water holding | Rasa: Madhura |
| seeds and | proportion of insoluble | capacity: 13.0 g/g | (Sweet), Amla |
| vegetables. (one | dietary fibers (52%). The fat | Oil absorption | (Sour) |
| or more of passion | and water retention of dietary | capacity: 2.0 g/g | Guna: Guru |
| fruit albedo, chia, | fibers is related to their | | (heavy) |
| flaxseed, pea, and | content of cellulose, | | Viraya: Ushna(Hot) |
| substitutes | hemicellulose and pectin. The | | Vipak: Katu |
| imparting the | cellulose interlinks with | | (Pungent) |
| same properties | hemicellulose and forms | | |
| and functionalities | interspaces. This increases the | | |
| etc.) | surface area of fibers which | | |
| | contributes to the water and | | |
| | oil retention properties. | | |
| Fibers from whole | Oats are high in soluble fiber | Oat fiber is a rich | Rasa: |
| grains (one or | and have a neutral flavor; | source of β- | Madhura(Sweet) |
| more of oats, | they retain water, and reduce | glucan which | Guna: |
| quinoa, amaranth, | water loss during cooking. | attributes to the | Guru(Heavy) |
| millets, and | Oats contain β-glucan (fiber) | water binding | Viraya: Ushna(Hot) |
| substitutes | which helps functionality as a | ability of β- | Vipak: |
| imparting the | binding agent. Oat fiber | glucan. | Madhura(Sweet) |
| same properties | provides flavor, texture and | Cooking yield: | |
| and functionalities | mouthfeel of fat. Oat fiber | (74.19%) | |
| etc.) | also helps retain moisture | Fat retention: | |
| | content, making it an ideal | (79.74%) | |
| | component of | Water retention: | |
| | meat and alternative meat | (48.41%) | |
| | emulsion formulations, | Textural quality | |
| | resulting in a food product | of the end food | |
| | that resists drying out. | product is | |
| | | enhanced by | |
| | | reducing the fat | |
| | | content and | |
| | | adding oat fiber | |
| Plant-derived | Tapioca starch has an | Effect on | Rasa: Madhura |
| starch (one or | amylopectin/amylose ratio of | viscosity: | (Sweet) |
| more of tapioca, | 80:15. The pulpy texture | amylopectin | Lavana (Salty) |
| potato, rice, and | results from highly cross- | increases the | Guna: |
| substitutes | linked and gelatinization | viscosity and | Virya: Hima/Sheeta |
| imparting the | forming tapioca pregels. | softness of a food | (Cold) |
| same properties | | product. | Vipaka: Madhura |
| and functionalities | | Molecular | (Sweet) |
| etc.) | | composition | |
| | | contributes to | |
| | | retaining the | |
| | | springiness of | |
| | | meat alternatives. | |

TABLE 5
Typical formulation for commercially available meat-based
burgers including preservatives and other chemical additives.

| | Weight | |
|---|---|---|
| Meat-based | percent | |
| Ingredient/category | of burger | Function |
| Beef/Pork | 60-70 | Meat-based protein and fat source |
| Water | 10 | Moisture |
| Beef Fat | 15-20 | Animal fat source |
| Soy Protein | 10-15 | Protein source |
| Salt | 10-15 | Flavor |
| Caramel color | 5-15 | Colorant |
| Sodium polyphosphates | 2-4 | Stabilizer, meat curer |
| Maltodextrin | 0.25-0.75 | Fat replacer, shelf life extender |
| Cochineal carmine | 5-15 | Colorant |
| Monosodium glutamate | 0.1-0.8 | Flavoring agent |
| Onion | 5-10 | Preservative, flavor enhancer |
| Garlic | 5-10 | Preservative, flavor enhancer |
| Cumin | 1-5 | Preservative, flavor enhancer |
| Sodium erythorbate | 0.5-0.7 | Cure accelerator |
| Natural beef/pork flavors | 1-2 | Flavor |
| Sodium citrate | 2-3 | Acidity regulator |
| Disodium inosinate | 0.1-0.3 | Flavor enhancer |
| Sodium guanylate | 0.1- 0.3 | Flavor enhancer |
| Black pepper | 1-5 | Flavor enhancer |
| Capsicum | 1-5 | Flavor enhancer |
| Soybean | 10-40 | Textured vegetable protein |
| Nisin | 0.01-0.05 | Preservative |
| Nitrites and Nitrates | 1-5 | Taste, colorant, antimicrobial |
| Phosphate Salts | 0.1-0.5 | Moisture retention, stabilizer, shrinkage |
| | | reducer, flavor enhancer, colorant |
| Tertiary butylhydroquinone | 0.02-0.03 | Antioxidant |
| (TBHQ) | | |

TABLE 6
Typical formulation for commercially available, plant-based burgers

| | Weight | |
|---|---|---|
| Plant-based Burger | Percent | |
| Ingredient/Category | of Product | Function |
| Pea protein isolate | 70-80 | Protein source |
| Water | Variable | Moisture |
| Expeller-pressed canola oil | 2-5 | Fat source |
| Refined coconut oil | 20-25 | Fat source |
| Cellulose from bamboo | ≤2 | Texturizer |
| Methylcellulose | 0.1-2 | Thickener, emulsifier |
| Potato starch | 2-4 | Thickener |
| Flavoring agents | 10-15 | Flavor |
| Maltodextrin | 0.2-0.9 | Fat replacer, shelf life extender |
| Yeast extract | 1-2 | Flavor enhancer |
| Salt | 2-5 | Flavor |
| Sunflower oil | 8-10 | Fat source |
| Vegetable glycerin | 5-15 | Sweetener |
| Dried yeast | 1-3 | Flavoring agent |
| Gum arabic, konjac gum, xanthan | 0.1-1 | Emulsifier, stabilizer, thickener, foaming |
| gum, Locust bean gum, carrageenan | | agent, texturizer, moisture retention. |
| Citrus extract (to protect quality) | 1-3 | Antimicrobial, preservative |
| Ascorbic acid (to maintain color) | 0.1-1 | Color retention |
| Beet juice extract (for color) | 5-10 | Colorant |
| Acetic acid | 0.5-2 | Shelf life extender |
| Succinic acid | 1-2 | Acidulant/flavoring agent |
| Modified food starch | 5-15 | Texturizer |
| Annatto (for color) | 2-5 | Colorant |

Table 6 provides an overview of the typical formulation of a commercially available, plant-based burger or burger mix, with numerous chemical additives. Although a somewhat improved profile compared to the profile of the formulation of the meat-based burger shown in Table 5, it can be improved for certain consumer diets with the use of plant-only replacements such as the methylcellulose replacement system. The methylcellulose replacement system may also be used to improve the quality of meat-based food products intended for pets and other animals.

TABLE 7
Comparison of formulations of plant-based burgers and burger
mixes versus commercially available plant-only burgers and burger mixes,
indicating relevant replacements for traditional additives in plant-based burger

| Example Formulation of | |
|---|---|
| Commercially Available | |
| Plant-based Burger Products | Plant-only Formulation for Burger Products Replacing |
| with Traditional Additives | methylcellulose and other Traditional Additives |
| Pea protein isolate | One or more protein source(s) (peas, lupine, mushrooms, |
| | quinoa, chickpea, etc.) |
| Water | Water (from plant or external source) |
| Expeller-pressed canola oil | One or more oils (sunflower, coconut, flaxseed and rice bran, |
| Refined coconut oil | etc.) containing high levels of MUFAs, omega-3 fatty acids, & |
| Sunflower oil | MCTs |
| Cellulose from bamboo | Plant-only methylcellulose replacement system (blend of five |
| Methylcellulose | categories of ingredients: protein, fibers from whole grains; |
| | fibers from fruits, seeds and vegetables, vegetable binding |
| | agents and starches as shown in Tables 2 & 3) (0.5-30% |
| | weight of the plant-only burger product depending if |
| | water or other liquid is included in the burger product). |
| Annatto (for color) | Plant-only flavorants, nutraceuticals |
| Natural flavor | (one or more of cumin, coriander, paprika, black pepper, etc.) |
| | Plant-only umami flavor replacement system (one or more of |
| | shiitake and other mushrooms, onions, tomatoes, lotus stem, |
| | garlic mineral salts, etc.) |
| Maltodextrin | Plant-only shelf life extender |
| | (one or more of garlic, black pepper, oregano, bay leaf etc.) |
| Yeast extract | Flavor enhancer (one or more of nutritional yeast, cashews etc.) |
| Vegetable glycerin | Plant-only leavening agent replacement system (one or more of |
| Dried Yeast | psyllium husk, apple pomace, rice starch, faba beans, plum |
| | powder, etc.) |
| Salt | Mineral Salts (Himalayan pink salt, sea salt, etc.) |
| Gum arabic, konjac gum, | Plant-only gums and carrageenan replacement system (one or |
| xanthan gum, locust bean | more of quince seed, apple, mesquite, almond, etc.) |
| gum, carrageenan | |
| Citrus extract (to protect | Plant-only leghemoglobin (one or more of beets, red radish, etc.) |
| quality) | |
| Ascorbic acid (to maintain | |
| color) | |
| Beet juice extract (for color) | |
| Acetic acid | Plant-only shelf life extender (one or more of garlic, black |
| | pepper, onion, etc.) |
| Succinic acid | Plant-only flavor enhancer (one or more of paprika, black |
| | pepper, beet juice, etc.) |
| Modified food starch | Plant-only modified starches replacement (one or more of |
| Potato starch | tapioca, fava bean, sorghum, quinoa, etc.) |

The plant-only formulations in Table 7 include any substituted plant-only ingredients that provide the same or similar functionality and properties as those ingredients listed.

### Functionality of Replacement Systems for Burger Products

The unique combination of essential ingredients in each plant-only replacement system or combinations of ingredients provides certain functionalities necessary for quality, plant-only burger products, as shown in the following table 8. Table 8 below provides a detailed description of the functionality of the various plant-only replacement systems and other categories of ingredients specific to plant-only burger products, as determined by the machine learning system.

TABLE 8
Functionalities Provided by Plant-Only Replacements in Burger Products

| | Plant-only | Plant-Only Ingredients, Ingredient |
|---|---|---|
| | Burger Product | Combinations or Replacement Systems |
| | Essential | Enabling Functionality within the Burger |
| Function | Ingredients | Product Composition |
| Emulsifier | One or more oils | Sunflower oil is primarily (85%) unsaturated fatty |
| | providing high | acids comprising 14-43% oleic acid and 44-75% |
| | levels of MUFAs, | linoleic acid, the latter, which results in the oil's |
| | omega 3 fatty acids, | lower freezing point, and contributes to the lower |
| | & MCTs (sunflower | freezing points of products in which sunflower oil |
| | oil coconut oil, | is added. |
| | flaxseed oil, rice | Coconut oil, in contrast, is ~87% saturated fatty |
| | bran oil, or other oil | acids, lauric acid accounting for ~49% of the |
| | substitute exhibiting | saturated fats. Other saturated fatty acids include |
| | similar properties | myristic, palmitic, stearic, oleic, capric and |
| | and functionalities) | caprylic acids. |
| | | Flaxseed comprises ~35-45% oil and 20-30% |
| | | protein. The oily portion consists of 9-10% |
| | | saturated fatty acids (palmitic and stearic), ~20% |
| | | monounsaturated fatty acids (mainly oleic acid), |
| | | and more than 70% alpha-linolenic fatty acids |
| | | acid. |
| | | Rice bran oil consists of ~74% unsaturated fatty |
| | | acids (~30% linoleic acid, ~44% oleic acid), and |
| | | the remaining ~23% are saturated fatty acids. |
| Thickening | Thickeners and | Chickpea fractions (starch, proteins) function as |
| agents / | binding agents (one | binders and are also a protein source (72-85% are |
| binding agent | or more of | globulins and albumin. Protein matrices formed |
| | chickpeas, oat fiber, | have the ability to hold water and fat. Their |
| | passion fruit, | binding properties are also attributable to water- |
| | aquafaba, sugar | soluble and insoluble carbohydrates: cellulose, |
| | beet pectin, and | starch and hemicellulose. Soluble carbohydrates |
| | substitutes with | have higher water binding capacities, and water |
| | similar | soluble- and insoluble polysaccharides also absorb |
| | functionalities and | oil. |
| | properties) | Oat fiber retains water, decreases cooking losses |
| | | and has neutral flavor. Oats have a fiber type of β- |
| | | glucan, a soluble fiber accounting to 4%. It depicts |
| | | functional properties as a potential binding agent. |
| | | Oat fiber provides the flavor, texture and |
| | | mouthfeel of fat. |
| | | Passion fruit has a high proportion (52%) of |
| | | insoluble dietary fiber (cellulose, hemicellulose, |
| | | and pectin), which contributes to strong fat and |
| | | water retaining abilities. The fruit contains |
| | | moderate length cellulose fibers, contributing to a |
| | | moderate ability to retain fat. Cellulose interlinks |
| | | with hemicellulose and forming a fiber net, |
| | | increasing the surface area of individual fibers, and |
| | | contributing their water and oil retention |
| | | properties. |
| Texturiser/ | Modified starch | Tapioca starch is an excellent thickener, binder, |
| Gelling agent | replacement system | texturizer and stabilizer. Sometimes called tapioca |
| | for (one or more of | flour, this starch originates from the cassava plant. |
| | tapioca, fava bean, | Gelatinized (tapioca) starch can hold a significant |
| | sorghum, quinoa | amount of water, which helps improve the texture |
| | etc.) | of many food products, including burgers and |
| | | burger mixes. |
| | | The fava bean protein is glossy and sticky, and is |
| | | an important emulsifier, foam stabilizer, and |
| | | contributes to gel formation. Its protein |
| | | constituents include globulin and albumin |
| | | accounting for ~25-30% of its content; these |
| | | proteins do not contribute as much as the other |
| | | constituents to the gelling capacity. |
| | | The quinoa starch is relatively low in amylose |
| | | content (e.g., 11%), and has very small granules (1 |
| | | to 3 μm) The starch has unique properties such as |
| | | low pasting temperature, high freeze-thaw |
| | | stability, and water holding capacity. The protein |
| | | from quinoa flour helps provide structure and |
| | | shape to the system. The protein and starch both |
| | | contribute to the gelling property. |
| | | Sorghum starch consists mainly amylopectin and |
| | | amylose. While heating, the gelatinization of |
| | | starch occurs due to hydrogen bonds being broken |
| | | within the starch granule due to water influx, |
| | | which results in granular swelling, increasing |
| | | viscosity, which thickens and texturizes the food |
| | | product. |
| Shelf life | Plant only shelf life | Garlic (Allium sativum) is one of the commonly |
| extender; | extenders | used plants to enhance flavor. It produces a wide |
| preservative, | comprising any one | spectrum of actions which have led to its use as an |
| flavoring | or more of herbs | antibacterial, antifungal, and antioxidant agent. |
| agent, | and spices, | The presence of allicin, a sulfur-containing |
| stabilizer | including garlic | compound, is responsible for the antimicrobial |
| | extract, Himalayan | effects. |
| | pink salt; black | Himalayan pink salt contains substantially higher |
| | pepper, oregano, | levels of calcium, iron, magnesium, manganese, |
| | bay laurel and any | potassium, aluminum, barium, silicon, and sulfur, |
| | substitutes of these | but lower levels of sodium compared to the white |
| | exhibiting similar | table salt |
| | functionality and | Black pepper, Piper nigrum, has piperine in higher |
| | properties. | amounts that enables the antimicrobial activity. |
| | | Terpenes and flavonoids also contribute to its |
| | | activity. The essential oil content in black pepper |
| | | mainly consists of caryophyllene (30.3%) and |
| | | limonene (12.12%), both of which also contribute |
| | | to its antimicrobial activity. |
| | | Oregano, Origanum vulgare, along with its flavor |
| | | imparting action, contributes to antimicrobial and |
| | | antioxidant properties. The major components of |
| | | oregano essential oil are carvacrol, β-fenchyl |
| | | alcohol, thymol, and γ-terpinen. These compounds |
| | | have a free radical scavenging effect contributing |
| | | to enhanced shelf life. |
| | | Bay leaf contains 1.3% essential oils that |
| | | contribute to both flavor and shelf life |
| | | enhancement. These oils include primarily |
| | | eucalyptol (45%) but also other terpenes (~12%), |
| | | terpinyl acetate (8-12%), sesquiterpenes (3-4%), |
| | | methyl eugenol (3%), and smaller amounts of |
| | | other α- and β-pinenes, phellandrene, linalool, |
| | | geraniol, terpineol and lauric acid. These |
| | | compounds exhibit radical scavenging and |
| | | antimicrobial activity. |
| Flavoring | Umami flavor | Meat and other animal-based products can be |
| agent/ | source(s) (one or | replaced in some food products with one or more |
| umami flavor | more of shitake and | types of mushrooms without compromising flavor, |
| | other mushroom | and can improve nutritional quality by reducing |
| | types, onions, | sodium, calories, saturated fat, and cholesterol |
| | tomatoes, lotus, | content. Mushrooms impart an “umami” flavor |
| | stem, garlic, salt, | because of their flavor-enhancing compounds, |
| | and substitutes for | most noticeably the eight carbon (C8) volatile |
| | these exhibiting the | compounds. Among all C8 compounds, the most |
| | same functionality | important for mushroom flavor are oct-1-en-3-ol, |
| | and properties) | octan-3-ol, octan-3-on and oct-1-en-3-on. |
| | | Onion (Allium cepa L.) contains high levels of |
| | | flavonoids that enhance the flavor of food |
| | | products. Onions contribute to the umami flavor |
| | | of food with their high glutamic acid content (~25 |
| | | to 50 mg/100 g). |
| | | Tomatoes impart a unique flavor, the result of a |
| | | complex mix and interaction among sugars, acids, |
| | | and volatile compounds. They also are high in |
| | | glutamate (~250 mg/100 g). |
| Flavorants, | One or more | Paprika oleoresin contains a number of carotinoids |
| flavor | flavorants, flavor | and pigments, including, among others, capsanthin |
| enhancers, | enhancers, | and capsorubin, which are strong antioxidants. |
| nutraceutical | nutraceuticals (one | Paprika is low in capsaicin, the pungent (hot) |
| | or more of herbs | compound found in red peppers. |
| | and spices such as | Methoxypyrazines” in paprika are responsible for |
| | cumin, paprika, | its vegetative flavor. The sweetness of paprika |
| | coriander, black | comes from a sugar content (up to 6%). Paprika |
| | pepper, onion, or a | has important bioactive compounds such as |
| | substitute for any | carotenoids, quercetin glycosides, and luteolin, all |
| | one or more of | of which exhibit high antioxidant activity. |
| | these that exhibit | Onions (Allium cepa L.) contain phytonutrients |
| | the same | such as: flavonoids, fructooligosaccharides (FOS), |
| | functionality and | thiosulfide and other sulfur compounds, which are |
| | properties) | recognized as important elements of highly |
| | | nutritional molecules. Quercetin is the main |
| | | flavonoid present in onions, exhibiting antioxidant |
| | | and antimicrobial properties. |
| | | Black pepper (P. nigrum) contains numerous |
| | | flavor compounds and has antimicrobial and |
| | | antioxidant properties. The primary volatile flavor |
| | | compounds include terpenes: monoterpene |
| | | hydrocarbons (59.2-80.1%) and sesquiterpene |
| | | hydrocarbons (17.0-37.7%) while oxygenated |
| | | terpenoids accounted for about 1.3-2.7%. Key |
| | | odorants of black pepper are α- and β-pinene, |
| | | myrcene, α-phellandrene, limonene, linalool, |
| | | methyl propanal, 2- and 3-methylbutanal, butyric |
| | | acid, germacrene, and 3-methylbutyric acid. The |
| | | spiciness of black pepper comes from Piperine. |
| | | Germacrene is potent, spicy, warm and has a sweet |
| | | aroma. In contrast, limonene is sweet, orange, |
| | | citrus and terpy. The essential oil content in black |
| | | pepper mainly consists of caryophyllene (30.3%) |
| | | and limonene (12.12%) also contribute to |
| | | antioxidant activity. |
| | | Cumin is a seed spice belonging to the family |
| | | umbelliferae. Cumin and products flavored by |
| | | cumin are used in food products and perfumery. |
| | | Cumin contains ~2.3 to 4.8% of volatile oils. The |
| | | characteristic odor of cumin is mainly due to the |
| | | aldehydes present in the seeds, namely, |
| | | cuminaldehyde (45-50%), p-menth-3-en-7-al and |
| | | p-menth-1,3-dien-7-al. Other major compounds |
| | | present in cumin contributing its distinct flavor |
| | | include: cuminal (8-17%), β-pinene (22-27%), β- |
| | | myrcene (1.3-1.75%), ρ-cymene (23-39%), γ- |
| | | terpinene (11-27%), and ρ-mentha-1,4-dien-7-ol |
| | | (1.0-5.5%). |
| | | Coriander, Coriandrum sativum, has a |
| | | characteristic flavor is due to terpenes. The |
| | | essential oils present in oil glands in the mericarp |
| | | and the linalool, with its floral and pleasant scents |
| | | also contribute to flavor enhancement. |
| | | Phenolics compounds present in the coriander |
| | | seeds such as gallic acid, caffeic acid, ellagic acid, |
| | | quercetin, kaempferol contribute to the antioxidant |
| | | activity. |
| Thickener, | methylcellulose | Pea fiber contains insoluble fibers and higher |
| Binding agent, | replacement | protein content, which contribute to its ability to |
| Stabilizer | system: ingredients | hold water. The combination of protein and fiber |
| | from all five | also leads to the higher oil absorbing capacity. |
| | categories detailed | Peas contain a high amylose starch content (25- |
| | in Table 1 (proteins; | 29%) that enables it to bind water and oil. |
| | fibers from whole | Oat fibers retain water, decreases cooking loss, and |
| | grains, fruits, seeds | it has a neutral flavor. Oats contain 4% (by weight) |
| | and vegetables; | of β-glucan, a soluble fiber with potential binding |
| | starches; and | abilities. Oat fiber provides flavor, texture, and |
| | vegetable binders) | mouthfeel of fat. In addition, β-glucan also |
| | within the ranges | contains hydrocolloids that provide emulsion |
| | indicated for the | stability, modifying the gelation process and |
| | replacement system | increasing viscosity. β -glucan forms a porous |
| | | network in a protein-gel matrix, e.g., holding fat |
| | | globules in the burger system. |
| | | Chickpeas contain starch and protein, and act as |
| | | binder and stabilizer. Chickpea proteins include |
| | | globulins and albumin, which act as binding |
| | | proteins; these binding proteins constitute 72-85% |
| | | of the weight of the chickpea, and function as |
| | | thickeners and binders by forming protein matrices |
| | | that hold water and fat. |
| | | Quinoa starch is relatively low (e.g., 11%) in |
| | | amylose and appears as small granules (1 to 3 μm). |
| | | Quinoa starch has unique properties: low pasting |
| | | temperature, high freeze-thaw stability, and water |
| | | holding capacity. The Quinoa starch granules are |
| | | small, polygonal, and in the range of 0.5-3 μm; |
| | | they function as a stabilizer for creating pickering |
| | | emulsions. The proteins from quinoa flour help |
| | | provide structure and shape to the food product. |
| Hydro | gums and | The main fraction of quince seed gum are high- |
| Colloids- | carrageenan | molecular-weight polysaccharides, the most |
| gelling, | replacement system | abundant among them which is d-Xylan, with |
| emulsifier, | (one or more of | many glucuronic acid residues. The presence of |
| stabilizer, | quince seed, apple, | proteins in quince seed gum (2.2%) affects the |
| sequestrant | mesquite, almond, | interfacial tension at the oil-water interface, and |
| | or substitutes | contributes to its ability to act as an emulsifier. |
| | thereof exhibiting | Almond gum is mainly composed of 92.36% of |
| | the same properties | polysaccharides (dry weight basis) with the major |
| | and functionality) | sugar composition comprising: arabinose |
| | | (46.83%), galactose (35.49%) and uronic acid |
| | | (5.97%). It also contains a small amount of |
| | | protein (2.45%) |
| | | Mesquite gum is a complex carbohydrate and is |
| | | comprised of D-galactose, L-arabinose, D- |
| | | glucuronate, D-mannose and D-xylose. |
| | | Apple pomace pectin is a low methylcellulose |
| | | pectin, it forms a thermo-irreversible gel, |
| | | remaining in a gel consistency even at high |
| | | temperatures that would normally melt pectin. |
| | | Pectins aid in the formation of smaller droplet size |
| | | emulsions, showing higher stability and forming a |
| | | gel-like consistency. The action of the insoluble |
| | | fibers in pectin maintain their stability in |
| | | emulsions through pickering mechanism and |
| | | through network formation in the continuous |
| | | phase; this may be favored by stabilization of |
| | | proteins and pectin in the soluble fraction. |
| Flavoring | Flavor enhancer, | Nutritional yeast is a food additive made from a |
| agent | nutritional yeast | single-celled organism, Saccharomyces cerevisiae, |
| | (one or more of | a member of the fungi kingdom. This yeast is |
| | nutritional yeast, | grown on molasses and then harvested, washed, |
| | cashews and any | and dried with heat to kill or deactivate it. |
| | substitute for either | Cashews contain esters (methyl 3-methyl |
| | one that exhibits the | butanoate, ethyl 3-methyl butanoate, methyl |
| | same functionality | butanoate, ethyl butanoate, ethyl trans-2-butenoate |
| | and properties) | and methyl 3-methyl pentanoate) which impart a |
| | | sweet, fruity taste and aroma. |
| Leavening | Leavening agent | Apple cider vinegar is the fermented juice of |
| agent(s) | replacement system | crushed apples, containing acetic acid, which |
| | (one or more of | contributes to the leavening action in food |
| | plum powder, apple | products. |
| | cider vinegar, vegan | Dried plums contain about 2% naturally occurring |
| | buttermilk, or other | malic acid, which serves as the natural acid |
| | substitutes that | component of chemical leavening systems. Dried |
| | exhibit the same | plums can also act as a natural preservative, |
| | functionality and | inhibiting microbial spoilage. |
| | properties in the | Vegan buttermilk is made by combining almond |
| | food product) | milk with acidulants. The high fat content |
| | | combined with acids result in curdling. |
| Lipid | Lipid peroxidation | Black pepper (P. nigrum) with piperine as an |
| peroxidation | inhibitors (one or | active ingredient, holds rich phytochemistry that |
| inhibitor, | more of black | also includes volatile oil, oleoresins, and alkaloids. |
| antioxidant, | pepper, bay leaf, | Black pepper oleoresins impart taste and exhibit |
| flavor enhancer | cumin, or | antioxidant properties. They are also used as a |
| | substitutes that | colorant and a food preservative because of their |
| | exhibit the same | antimicrobial properties. β-Caryophyllene, |
| | functionality and | limonene, β-pinene, α-pinene, δ-3-carene, |
| | properties) | sabinene, and myrcene are the main components of |
| | | this oil. |
| | | Bay leaves showed radical scavenging activity due |
| | | to the presence of sesquiterpene lactones, |
| | | alkaloids, and glycosylated flavonoids. The |
| | | kaempferol C-glycoside is the major contributor to |
| | | antioxidant properties. |
| | | Cumin's antioxidant activity is correlated with the |
| | | presence of high polyphenols, mainly flavonoids. |
| | | The essential oils present - carvacrol, anethole, and |
| | | terpineol - also contribute to the function of radical |
| | | scavenging. |
| Color | One or more | Leghaemoglobin is a protein that binds oxygen and |
| retention, | sources of | is found in the root nodules of leguminous plants; |
| coloring agent, | leghaemoglobin | it is often used as an ingredient in some plant- |
| nitrite | (one or more of | based meat substitutes. |
| replacement | beets, red radishes | Red beet - B. vulgaris - is one of the top ten most |
| | or any substitute | potent antioxidant-rich vegetables. Betalains |
| | exhibiting the same | (including betanin/betanidin) exhibit high |
| | functionality and | antioxidant activity. Red radish and beet powders |
| | properties as do | exhibit antioxidant activity and are high in nitrates. |
| | these ingredients) | Radish powder in particular prevents meats and |
| | | meat substitutes from changing color. |

### Preparation of the Methylcellulose Replacement System or its Component Categories

At step 102, a) 15-20% by weight of a plant-derived protein source, b) 10-25% by weight of a vegetable binding agent source, c) 15-20% by weight of a fruit, seed, and vegetable fiber sources, d) 15-20% by weight of a whole grain fiber source, and e) 5-15% by weight of a plant-derived starch source are mixed at a temperature ranging between 60 degree Celsius and 105 degree Celsius for about 30 seconds to one minute to form a homogeneous mixture of the plant-only replacement system for methylcellulose.

In one embodiment the methylcellulose replacement system, or any of its individual categories and blends of ingredients, can be prepared by combining and mixing the dried, powdered ingredients selected from Table 2 in the relative amounts identified as preferred, essential ingredients of the system to be used in a desired food product. In some embodiments the methylcellulose replacement system may be in the form of a liquid or gel due to the addition of water or other plant-derived liquid to one or more of the ingredients or categories of ingredients before mixing, such as, for example, aquafaba in liquid form. In some embodiments, the methylcellulose replacement system is mixed with additional water or plant-derived liquid, then dried and powdered and stored. In some embodiments, the methylcellulose replacement system is prepared in liquid form and freeze-dried. In certain embodiments, the methylcellulose replacement system may be prepared and stored in a liquid or moist form (as in a gel or dough). In certain other embodiments, the methylcellulose replacement system may be prepared as a liquid, gel or in dried form and then frozen for storage. In other embodiments, each of the categories of ingredients or blends of the methylcellulose replacement system, whether in liquid, gel, dried or other form, are mixed individually directly into and become a part of another food product rather than being combined as the complete replacement system prior to incorporation into another food product.

In some embodiments, the methylcellulose replacement system stands alone as a plant-only food product. In other embodiments, the methylcellulose replacement system is a component of another food product, such as a plant-only burger product, or other imitation meat product. In certain embodiments, the methylcellulose replacement system is a component of a baked good food product, or a frozen burger or burger mix, which may then be incorporated into other food products. In still other embodiments, the food product is one of several components used to create the final food product. In other embodiments, the food product is a Traditional Burger Product. In some embodiments, the ingredients of Table 2 may be selected and combined in other relative amounts (a variety of ranges) identified for each of the five methylcellulose replacement system categories discussed infra to achieve the required functional characteristics most closely resembling those of methylcellulose in a variety of food products, including, e.g., Traditional Burger Products.

In some embodiments, chickpea protein flour is used as the plant-derived protein source. The chickpea protein isolates are obtained by micellization and isoelectric precipitation. Proteins from defatted flour are extracted using sodium chloride for the micellization method. By ultrafiltration, this extract is concentrated to half its original volume. It is done using a membrane cartridge with a molecular weight cut-off of 10 kD. By adding water at 4° C. (1:4 v/v, protein extract:water) and pH 7.0, proteins are flocculated. Proteins from defatted flour are extracted with alkali (0.1 N NaOH) for isoelectric precipitation, and then precipitated by adding acid (0.1 N HCl) to pH 4.5. Centrifugation at 10,000×g for 10 min is used to recover the isolates, which are then dried. High water-holding and binding capacity of the protein causes the formation of a gel matrix which in turn results in a more stable product and more viscosity. The molecular weight of the protein range between 10-50 kDa. Oil Holding Capacity is desired in meat formulations, flavor retention, and improvement of palatability. Due to higher fat absorption, chickpea protein flour may be more appropriate to be used in foods for which fat retention is desirable.

TABLE 9
Comparison of Water holding capacity (WHC), Oil Holding Capacity
(OHC) and emulsion stability of the plant-derived protein source.

| | Pea | Pigeon pea | Mung bean | Soybean | |
|---|---|---|---|---|---|
| Property | protein | protein | protein | protein | Chickpeas |
| WHC | 170% | 87% | 200% | 600% | 107.96% |
| OHC | 120% | 173% | 135% | 200% | 124% |
| Emulsion | 62.7%′ | 73.38% | 66.5%′ | 99.7% | 94.3% |
| stability | | | | | |

In some embodiments, Aquafaba powder is used as the vegetable binding agent source. Chickpea seeds are boiled for 30 minutes after being steeped in 4° C. water for 16 hours to make a liquid aquafaba sample (100 g). After that, the sample is dried in an oven at 80° C. with forced air safety circulation until it had a noticeable consistency of powder. The Water Holding Capacity of the aquafaba is 4.36±0.20 g water/g sample, the Oil Absorption capacity is 4.6±0.26 g of oil/g of sample and the emulsion stability is about 75%. Proteins in aquafaba, for example, are amphiphilic molecules with a low molecular weight (25 kDa). These molecules can aggregate at the water-oil interface, lowering the interfacial tension of the solution and forming an intermolecular cohesive film with enough elasticity to stabilize emulsions. Polysaccharides enhance emulsion stability by gelling or changing the viscosity of the aqueous continuous phase, resulting in fewer droplet collisions.

In some embodiments, passion fruit peel pectin flour is used as the fibers from fruit, seed, and vegetable source. The passion fruit peels are separated, cleaned, and dried at 60 degrees Celsius before being sliced and ground in a blender. 250 mL of distilled water was added to the dried sample, which was then heated for 20 minutes at 80° C. To remove the residues, the suspensions were filtered through cheesecloth. The filtrate was coagulated with 90% ethanol and stirred for 15 minutes; the pectin was then washed. For a few hours, the pectin was dried in an oven set to 50° C. The passion fruit peel pectin flour includes a total dietary fiber of 62.64%, OHC of 4.05 g/g and WHC of 11.59 g water/g sample. Polysaccharides such as pectin can act as chelating agents for metals, either because of their acid groups with high affinity for cations or because of the substitution of water molecules in cation solvation into hydroxyl groups. These two factors explain the high copper-binding capacity of passion fruit peel. High cation-binding capacity helps stabilize emulsions as the metal polysaccharide complex prevents the metal from interacting with fatty acids, impeding its oxidation. High water holding capacity, combined with high-fat absorption capacity, indicates good emulsifying properties, facilitating the solubilization or dispersion of two immiscible liquids.

In some embodiments, oat fiber powder is used as a fiber from whole grain source. Oat seeds were manually cleaned of any foreign matter before being mechanically prepared into flour using a laboratory mill, sieved through a 60-mesh screen, and then refrigerated. Oat fiber includes a WHC of 7 g water/g sample and an OHC of 2 g/g. Oat fiber includes insoluble fiber (85%-90%), and is composed of lignin, cellulose, and hemicellulose. Oat fiber releases water at a slower rate than starches, thus less water is reaching the surface, thereby controlling and reducing the water activity of baked goods. The moisture retaining property/WHC and the cellulose content of oat fiber make it a potential humectant. Young's modulus of the oat fiber is 4.7 MPa.

In some embodiments. Tapioca starch is used as the plant-derived starch source. Clean, washed, peeled, and chopped cassava roots fed to a saw-tooth rasper for intense attrition into a pulpy slurry. Proteins, fibers, etc. are further removed from extractors and centrifugation. Starch slurry exits the coarse extractor equipped with a filter cloth and a screen with an aperture of a finer screen (140-200 mesh). Filtered starch is recovered from the final starch stream and dried. WHC of starch is a measure of hydration capacity because the determination is a weight measure of swollen starch granules and their occluded water. Food eating quality is often connected with the retention of water in the swollen starch granules. Amylose gives the gel strength and amylopectin gives high viscosity. Amylose content for tapioca is ˜ 17%, and amylopectin is 82%. Peak viscosity is the indicator of starch granule swelling and high-value peak viscosity indicates a high capacity of swelling of starch. Starches with high peak viscosity are possible to show high breakdown values, leading to weak gels. So it has to be in a medium range. The high pasting temperature of starches indicates a higher resistance to swelling and rupture.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the figures and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying figures.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A plant-only replacement system for methylcellulose in food products comprising:
a) 15-20% by weight of a plant-derived protein source, b) 10-25% by weight of a vegetable binding agent source, c) 15-20% by weight of a fruit, seed, and vegetable fiber sources, d) 15-20% by weight of a whole grain fiber source, and e) 5-15% by weight of a plant-derived starch source.

2. The plant-only replacement system for methylcellulose of claim 1, wherein the protein source is selected from peas, lupine, mushrooms, quinoa, chickpeas, soy protein, pigeon pea, mung bean protein, peanut, pinto beans, oats, or combinations thereof.

3. The plant-only replacement system for methylcellulose of claim 1, wherein the vegetable binding agent source is selected from aquafaba, quince seed, sugar beet pectin, garden cress root, okra mucilage powder, pumpkin pectin, carrot pomace pectin, sweet potato, taro, potato fiber or combinations thereof.

4. The plant-only replacement system for methylcellulose of claim 1, wherein the fruit, seed, and vegetable fibers are selected from passion fruit peel pectin powder, albedo, chia, flaxseed, pea, quinoa fibers, oat fiber, soy fiber, orange pomace, Phaseolus vulgaris flour or combinations thereof.

5. The plant-only replacement system for methylcellulose of claim 1, wherein the whole grain fiber source is selected from oats fiber, quinoa, amaranth, millet, barley, bulgur wheat, Farro, black rice, teff, rye, sorghum, triticale or combinations thereof.

6. The plant-only replacement system for methylcellulose of claim 1, wherein the starch source is selected from tapioca starch, potato starch, rice starch, jackfruit seed powder, taro starch, yam starch, arrowroot starch, cassava starch, wheat starch, or combinations thereof.

7. The plant-only replacement system for methylcellulose of claim 1, wherein the food products comprise meat-based products, salads, sauces, condiments, bread, pastries, vegetable burger and burger mixes, nuggets, baked stable sauces, battered and fried food items.

8. A method of preparing a plant-only replacement system for methylcellulose in food products, wherein the method comprises:
mixing a) 15-20% by weight of a plant-derived protein source, b) 10-25% by weight of a vegetable binding agent source, c) 15-20% by weight of a fruit, seed, and vegetable fiber sources, d) 15-20% by weight of a whole grain fiber source, and e) 5-15% by weight of a plant-derived starch source at a temperature ranging between 60 degree Celsius and 105 degree Celsius for about 30 seconds to one minute to form homogeneous mixture the plant-only replacement system for methylcellulose.

9. The method of claim 8, wherein the method includes blending the plant-only replacement system for methylcellulose with a formulation of the food product in a blender or bowl cutter.

10. The method of claim 8, wherein the plant-derived protein source, the vegetable binding agent source, the fruit, seed and vegetable fiber sources, the whole grain fiber source and the plant-derived starch source are obtained as a dried powder.

11. The method of claim 8, wherein the plant-only replacement system for methylcellulose is obtained as a gel or dough.

12. The method of claim 8, wherein the plant-derived protein source is selected from peas, lupine, mushrooms, quinoa, chickpeas, soy protein, pigeon pea, mung bean protein, peanut, pinto beans, oats or combinations thereof.

13. The method of claim 8, wherein the vegetable binding agent source is selected from aquafaba, quince seed, sugar beet pectin, garden cress root, okra mucilage powder, pumpkin pectin, Carrot pomace pectin, sweet potato, taro, potato fiber or combinations thereof.

14. The method of claim 8, wherein the fruit, seed and vegetable fiber is selected from passion fruit peel pectin powder, albedo, chia, flaxseed, pea, quinoa fibers, oat fiber, soy fiber, orange pomace, Phaseolus vulgaris flour or combinations thereof.

15. The method of claim 8, wherein the whole grain fiber source is selected from oats fiber, quinoa, amaranth, millet barley, bulgur wheat, farro, black rice, teff, rye, sorghum, triticale or combinations thereof.

16. The method of claim 8, wherein the plant-derived starch source is selected from tapioca starch, potato starch, rice starch, jackfruit seed powder, taro starch, yam starch, arrowroot starch, cassava starch, wheat starch or combinations thereof.

17. The method of claim 8, wherein the food products comprise meat-based products, salads, sauces, condiments, bread, pastries, vegetable burger and burger mixes, nuggets, baked stable sauces, battered and fried food items.

18. The method of claim 8, wherein physical characterization data associated with ingredients of the plant-only replacement system for methylcellulose comprising the plant-derived protein source, the vegetable binding agent source, the fruit, seed, and vegetable fiber sources, the whole grain fiber source and the plant-derived starch source is stored in a database, wherein a machine learning model determines a unique combination of the ingredients based on the physical characterization data to prepare the plant-only replacement system for methylcellulose.

19. The method of claim 18, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.
